(19) United States
(12) Patent Application Publication
(10) Pub. No.: US 2006/0239466 A1
(43) Pub. Date: Oct. 26, 2006

(54) Noise capture apparatus

(75) Inventor: Te-Liang Shen, Taipei (TW)

Correspondence Address: TROXELL LAW OFFICE PLLC;ONE SKYLINE PLACE, SUITE 1404, 5205 LEESBURG PIKE, FALLS CHURCH, VA, 22041, US

(73) Assignee: ECPAL VEHICAL Co., Ltd.

(21) Appl. No.: 11/222,858

(22) Filed: Sep. 12, 2005

(30) Foreign Application Priority Data
Apr. 22, 2005 (TW) 094206402

(51) Int. Cl. H04R 29/00

(52) U.S. Cl. 381/56

(57) ABSTRACT

The present invention relates to a noise capture apparatus, for capturing noise(s) generated by a movable mechanical device and outputting the noise(s) for analysis, which comprises: a housing, having at least one signal input opening and a signal output opening; a printed circuit board, disposed in the housing, for conveying following elements; a noise capture and output module, disposed on the printed circuit board, having at least one signal input socket and a signal output socket, wherein, the signal input socket could be exposed from the signal input opening and the signal output socket could be exposed from the signal output opening; and at least one sensor, coupled to the noise capture and output module through the signal input opening; thereby the noise(s) sensed by the sensor(s) could be amplified by the noise capture and output module then output through the signal output socket.

### REARGROUND OF THE INVENTION

1. Field of the Invention

The present invention relates to a noise capture apparatus, more particularly, it relates to a noise capture apparatus which has several sense channels to display the power level of the noises and an audio output device to output the noises, so that the user could quickly find the noise source by selecting the sense channels one by one and monitoring its power level as well as audio output.

2. Description of the Related Art
In general, the vehicle generally generates some unknown noise(s) during driving, the noise(s) will greatly bother the driver, and due to the unknown noise(s) could not normally regenerate when the driver drives the vehicle to the repair shop; furthermore, some unknown noise(s) is(are) generated under specific conditions, such as rainy day, damp day, downhill or climbing a hill etc., thus will bother the worker of the repair shop too, even the noise(s) is(are) regenerated in the repair shop, but the worker can not hear the noise(s) clearly due to its appearance is(are) out of control, so the noise(s) may be disappeared when the worker hears it, therefore, it is difficult to the worker to handle and process the noise(s) source.

For example, the Taiwan issued No. 429915 patent disclosed a noise(s) preventing structure for using in vehicle drum brakes, which disposes a cover inner a whole rotating drum. However, the object of the issued patent was to prevent the drum brakes from generating noise(s) when the drum brakes operated, but not with the ability to find the noise(s) source of a vehicle.

There is therefore a need for a new and improved strategy and technique of a structure of noise capture apparatus for overcoming these deficiencies and the present invention overcomes these deficiencies in a new and novel fashion.

### SUMMARY OF THE INVENTION

According to one aspect of the present invention, the present invention provides a noise capture apparatus which has several sense channels to display power level of the noise(s) and an audio output device to output the noise(s), so that the user could quickly find the noise source(s) by selecting the sense channels one by one and monitoring its power level as well as audio output.

For reaching the aforesaid object, wherein, the noise capture apparatus, which mainly comprises: a housing, having at least one signal input opening and a signal output opening; a printed circuit board, disposed in the housing, for conveying following elements; a noise capture and output module, disposed on the printed circuit board, having at least one signal input socket and a signal output socket, wherein, the signal input socket could be exposed from the signal input opening and the signal output socket could be exposed from the signal output opening; and at least one sensor, coupled to the noise capture and output module through the signal input opening; thereby the noise(s) sensed by the sensor(s) could be amplified by the noise capture and output module then output through the signal output socket.

### BRIEF DESCRIPTION OF THE DRAWING PORTIONS

FIG. 1 shows an exploded view of a noise capture apparatus according to one embodiment of the present invention.

FIG. 2 shows a block diagram of the noise capture and output module 3 according to one embodiment of the present invention.

FIG. 3 shows an assembled view of a noise capture apparatus according to one embodiment of the present invention.

FIG. 4a˜c shows a perspective view of the sensor 5, respectively according to one embodiment of the present invention.

### DETAILED DESCRIPTION OF THE PREFERRED EMBODIMENT

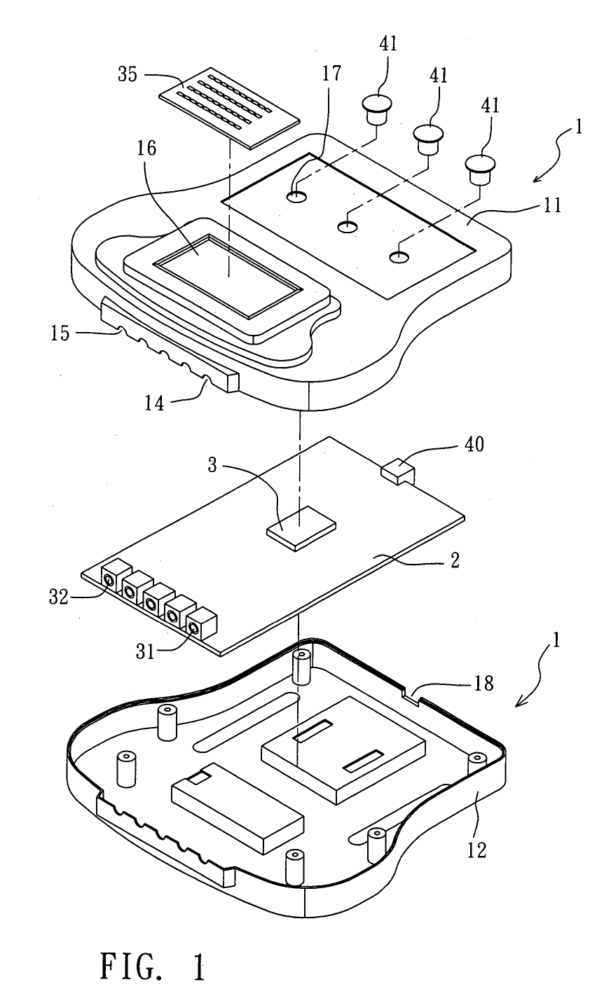

Referring to FIG. 1, it shows an exploded view of a noise capture apparatus according to one embodiment of the present invention. As shown in the Fig. the noise capture apparatus of the present invention is mainly used for capturing a noise(s) generated by a movable mechanical device and outputting the noise(s) for analysis, which comprises: a housing 1; a printed circuit board 2; a noise capture and output module 3; and at least one sensor 5.

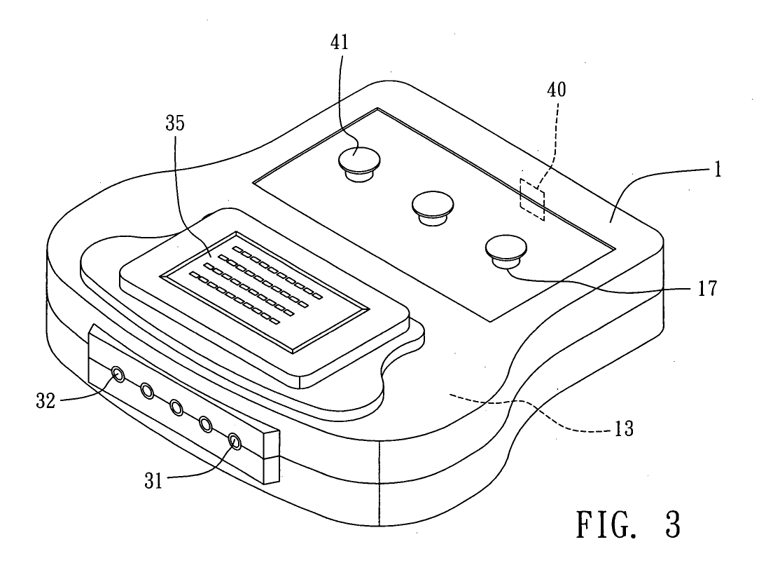

The housing 1 comprises an upper housing 11 and a lower housing 12, wherein, the upper housing 11 and lower housing 12 can be engaged each other so as to form a space 13 (please refer to FIG. 3), and one side of the upper housing 11 or lower housing 12 has at least one signal input opening 14 and a signal output opening 15 thereon. Furthermore, the upper housing 11 further comprises a first opening 16, a plurality of second openings 17 and a third opening 18.

The printed circuit board 2 is disposed in the space 13 formed by the upper housing 11 and lower housing 12, for conveying the noise capture and output module 3.

The noise capture and output module 3 is disposed on the printed circuit board 2, which has at least one signal input socket 31 and a signal output socket 32, wherein, the signal input socket 31 could be exposed from the signal input opening 14 and the signal output socket 32 could be exposed from the signal output opening 15.

The sensor(s) 5 is(are) coupled to the noise capture and output module 3 through the signal input socket 31, for sensing the noise(s) generated by the certain place of a vehicle, such as engine compartment. The noise(s) sensed by the sensor(s) 5 will be amplified by the noise capture and output module 3 then output through the signal output socket 32, therefore, the worker can hear the noise(s) amplified by the noise capture and output module 3 by way of using an earphone plugging therein the signal output socket 32.

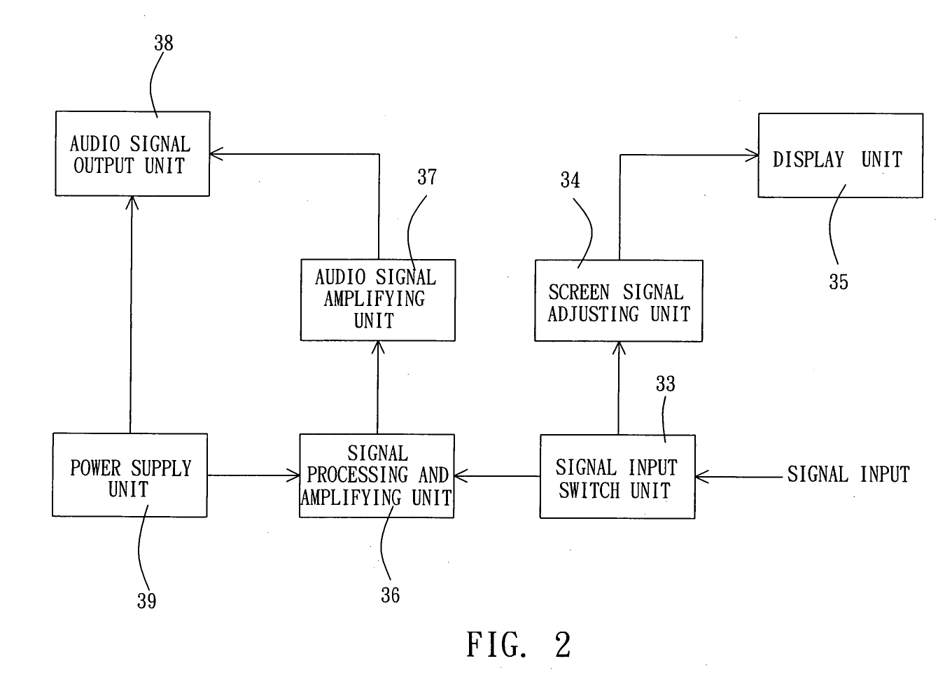

Referring to FIG. 2, it shows a block diagram of the noise capture and output module 3 according to one embodiment of the present invention. As shown in the FIG., the noise capture and output module 3 of the present invention further comprises: a signal input switch unit 33; a screen signal adjusting unit 34; a display unit 35; a signal processing and amplifying unit 36; an audio signal amplifying unit 37; an audio signal output unit 38; and a power supply unit 39.

Wherein, the signal input switch unit 33 is coupled to the sensor(s) 5 through the signal input opening 14, for choosing various noises sensed by the sensor(s) 5, wherein the signal input switch 33 unit is a select switch, preferably, which could be exposed from one of the second openings 17, for providing the user to select and switch the noise(s) sensed by the sensor(s) 5.

The screen signal adjusting unit 34 is coupled to the signal input switch unit 33 for adjusting the signals strength on the screen, wherein the screen signal adjusting unit 34 is a variable transistor, preferably which could be exposed from one of the second openings for providing the user to adjust the strength of the screen signals.

The display unit 35 is coupled to the screen signal adjusting unit 34 for display the strength of the noise signal(s), wherein the display unit 35 is display unit 35 is a LED display array or a LCD display, preferably. In one preferred embodiment of the present invention, the display unit 35 is using a LED display array as one example, but this is not limited the scope of the invention. The display unit 35 is exposed from the first opening for displaying the power level of the noise signal(s); wherein the amount of the sensor(s) 5 is equal to the amount of the signal input opening 14, in one preferred embodiment of the present invention, the amount of the sensor(s) 5 and signal input opening 14 is for example but not limited to four, respectively.

The signal processing and amplifying unit 36 is coupled to the signal input switch unit 33 for receiving the noise(s) sensed by the sensor(s) 5 then processing and amplifying.

The audio signal amplifying unit 37 is coupled to the signal processing and amplifying unit 36 for amplifying the noise(s); the audio signal output unit 38 is coupled to the audio signal amplifying unit 37 for outputting the noise(s), in one preferred embodiment of the present invention, the audio signal amplifying unit 37 outputs the audio signal to the signal output socket 32, thereby the user can hear the noise signal(s) sensed by the sensor(s) 5 by plugging an earphone into the signal output socket 32.

The power supply unit 39 is coupled to aforesaid elements for providing the operating power, wherein, the power supply unit 39 is a battery module, preferably, and the battery module can be disposed inside or outside of the housing 1. Furthermore, the present of the invention further comprises a power input socket 40, which could be exposed from the third opening 18 for providing an external power adapter (not shown) plugging therein.

Furthermore, the present invention further comprises a power switch and volume sensitivity adjusting button 41 (please refer to FIG. 1), which could be exposed from one of the second openings 17 for providing the user to control the power switch and adjust the sensitivity of the audio signal(s).

Referring to FIG. 3, it shows an assembled view of a noise capture apparatus according to one embodiment of the present invention. As shown in the FIG., in assembly, firstly, the noise capture and output module 3, signal input socket 31, signal output socket 32, signal input switch unit 33, power input socket 40 and power switch and volume sensitivity adjusting button 41 could be mounted onto the printed circuit board 2; then the printed circuit board 2 is disposed in the space 13 formed by the upper housing 11 and lower housing 12 and makes the signal input socket 31 as well as signal output socket 32 being exposed from the third opening 18 and second opening 17, respectively; finally, the power input socket 40 and power switch and volume sensitivity adjusting button 41 is exposed from the third opening 18 and second opening 17, respectively, so as to complete the assembly of the present invention.

In operating, the noise capture apparatus of the present invention could dispose four sensors 5 in the engine compartment of a vehicle (not shown), and drive the vehicle on the road; the sensors 5 could sense the noise(s) generated by the engine during driving the vehicle and input the noise(s) to the screen signal adjusting unit 34 and signal processing and amplifying unit 36 through the signal input opening 14; after processing, the noise(s) could be displayed on the display unit 35 as a power level form and could be outputted through the signal output socket 32 as an audio signal form, as well as co-operates with the signal input switch unit 33 to select one of four sensors 5, such that the noise signal(s) sensed by the selected sensor(s) 5 could be outputted to the signal output socket 32, therefore, the worker can see the power level of the noise(s) displayed on the display unit 35 and select the signal input switch unit 33 to listen the noise(s) sensed by every sensor 5, when the power level of the display unit 35 matching with the selected audio signal strength of the signal output socket 32, on the other hand, the power level of the display unit 35 is high and the audio signal strength of the signal output socket 32 is also high, therefore, the worker could make sure that the region disposed the selected sensor 5 generates the maximum noise(s); then disposing the other three sensors 5 to the nearby region generated the maximum noise(s) and using the same way, thus the worker could accurately find the noise source(s). Therefore, the noise capture apparatus of the present invention could overcome the drawbacks of the aforesaid prior arts.

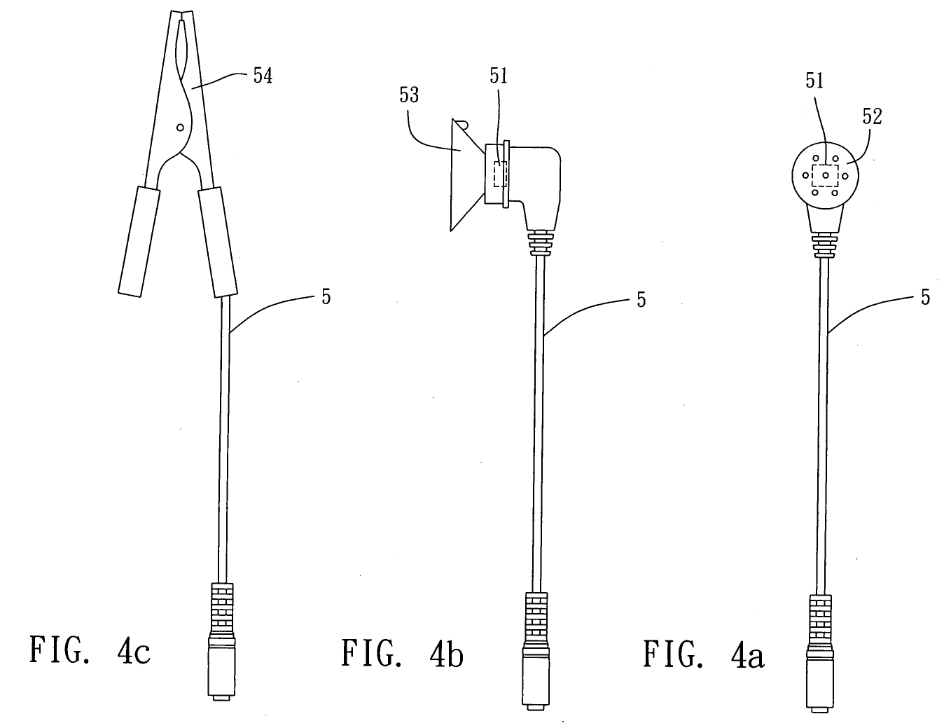

Referring to FIG. 4a˜4c, it shows a perspective view of the sensor(s) 5, respectively according to one embodiment of the present invention. As shown in the FIG. 4a, the sensor(s) 5 of the present invention could be a magnetic type microphone, which has a magnet 52 disposed in front of the microphone 51 for adhering the microphone 51 to the metal material of a vehicle by the magnet 52 so as to capture the noise(s) generated therein.

As shown in the FIG. 4b, the sensor(s) 5 of the present invention could be a suction cup type sensor, which has a suction cup 53 disposed in front of a microphone 51 for adhering the microphone 51 to the body of a vehicle by the suction cup 53 so as to capture the noise(s) generated therein.

As shown in the FIG. 4c, the sensor(s) 5 of the present invention could be a clip type sensor, which has a clip 54 disposed in front of a microphone 51 for clipping the microphone 51 to the body of a vehicle by the clip 54 so as to capture the noise(s) generated therein. Furthermore, the sensor(s) 5 further comprises an extended wire (not shown) for extending its sensing distance.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A noise capture apparatus, for capturing noise(s) generated by a movable mechanical device and outputting said noise(s) for analysis, which comprises:
a housing, having at least one signal input opening and a signal output opening;
a printed circuit board, disposed in said housing, for conveying following elements;
a noise capture and output module, disposed on said printed circuit board, having at least one signal input socket and a signal output socket, wherein, said signal input socket could be exposed from said signal input opening and said signal output socket could be exposed from said signal output opening; and
at least one sensor, coupled to said noise(s) capture and output module through said signal input opening;
thereby said noise(s) sensed by said sensor could be amplified by said noise capture and output module then output through said signal output socket.

2. The noise capture apparatus as claimed in claim 1, wherein said housing further comprises a first opening, a plurality of second openings and a third opening.

3. The noise capture apparatus as claimed in claim 2, wherein said noise capture and output module further comprises:
a signal input switch unit, coupled to said sensor through said signal input opening, for choosing various noises sensed by said sensor;
a screen signal adjusting unit, coupled to said signal input switch unit, for adjusting the strength of said screen signals;
a display unit, coupled to said screen signal adjusting unit, for display the strength of said noise signal(s);
a signal processing and amplifying unit, coupled to said signal input switch unit, for receiving said noise(s) sensed by said sensor(s) then processing and amplifying;
an audio signal amplifying unit, coupled to said signal processing and amplifying unit, for amplifying said noise(s);
an audio signal output unit, coupled to said audio signal amplifying unit, for outputting said noise(s); and
a power supply unit, coupled to aforesaid elements, for providing the operating power.

4. The noise capture apparatus as claimed in claim 3, wherein said signal input switch unit is a select switch, which could be exposed from one of said second openings, for providing user to select and switch said noise(s) sensed by said sensor(s).

5. The noise capture apparatus as claimed in claim 3, wherein said screen signal adjusting unit is a variable transistor, which could be exposed from one of said second openings, for providing user to adjust the strength of said screen signals.

6. The noise capture apparatus as claimed in claim 3, wherein said display unit is a LED display array or a LCD display, which could be exposed from said first opening, for display the power level of said noise signal(s).

7. The noise capture apparatus as claimed in claim 3, wherein said audio signal output unit outputs said noise signal(s) through said signal output socket.

8. The noise capture apparatus as claimed in claim 3, wherein said power supply unit is a battery module, which could be disposed inside said housing or outside said housing.

9. The noise capture apparatus as claimed in claim 3, wherein it further comprises a power input socket, which could be exposed from said third opening, for providing an external power adapter plugging therein.

10. The noise capture apparatus as claimed in claim 3, wherein it further comprises a power switch and a volume sensitivity adjusting button, which could be exposed from one of said second openings, for providing the user to control said power switch and adjust the sensitivity of said audio signal.

11. The noise capture apparatus as claimed in claim 1, wherein said sensor is a magnetic type microphone, which has a magnet disposed in front of said microphone, for adhering said microphone to the metal material of a vehicle by said magnet so as to capture said noise(s) generated therein.

12. The noise capture apparatus as claimed in claim 1, wherein said sensor is a suction cup type sensor, which has a suction cup disposed in front of a microphone, for adhering said microphone to the body of a vehicle by said suction cup so as to capture said noise(s) generated therein.

13. The noise capture apparatus as claimed in claim 1, wherein said sensor is a clip type sensor, which has a clip disposed in front of a microphone, for clipping said microphone to the body of a vehicle by said clip so as to capture said noise(s) generated therein.

14. The noise capture apparatus as claimed in claim 1, wherein said sensor further comprises an extended wire.

15. The noise capture apparatus as claimed in claim 1, wherein it further comprises an earphone, which could be plugged into said signal output socket, for providing the user to listen said noise(s) outputted by said noise capture and output module.

16. The noise capture apparatus as claimed in claim 1, wherein the amount of said signal input socket is four.
